(19) United States
(12) Patent Application Publication
(10) Pub. No.: US 2010/0111583 A1
(43) Pub. Date: May 6, 2010

(54) SHEET FEEDING DEVICE AND IMAGE FORMING APPARATUS

(75) Inventor: Keiko Fujita, Kashiwa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/605,481

(22) Filed: Oct. 26, 2009

(30) Foreign Application Priority Data
Nov. 6, 2008 (JP) 2008-285471

(51) Int. Cl. G03G 15/00; B65H 9/12; B65H 1/00

(52) U.S. Cl. 399/388; 271/241

(57) ABSTRACT

A sheet feeding device includes a sheet supporting portion which supports sheets, a restricting member which is movably disposed in the sheet supporting portion and is moved to a position according to the sheet supported by the sheet supporting portion, to restrict the position of the sheet; and a lock mechanism including a lock projection which is disposed in the restricting member so as to be pivotable in a movement direction of the restricting member and a plurality of lock grooves which are formed on a side of the sheet supporting portion and disengageably engage with the lock projection, so as to restrict movement of the restricting member in a direction reverse to a sheet restricting direction. The pivotal center of the lock projection in the lock mechanism is located downward of the position of an engaging portion between the lock projection and the lock groove.

### BACKGROUND OF THE INVENTION

1. Field of the Invention

The present invention relates to a sheet feeding device and an image forming apparatus and, more particularly, to a configuration in which a restricting member for restricting the position of a sheet is locked.

2. Description of the Related Art

In recent years, there has been widely prevailed an image forming apparatus such as a printer or a copying machine in which a sheet is fed to an image forming portion, and then, an image is formed on the sheet. Such an image forming apparatus is generally provided with a sheet feeding device for feeding sheets stacked in a sheet cassette or on a manual tray to the image forming portion by a sheet feeding member.

Here, the sheet cassette or the manual tray includes a side end restricting member for restricting the position of the stacked sheet in a widthwise direction perpendicular to a sheet feed direction such that sheets of various sizes can be stored in the sheet cassette or placed on the manual tray. In addition, there is provided a rear end restricting member for restricting the position of the rear end of the stored sheet in the sheet feed direction (see Japanese Patent Application Laid-open No. 2004-123292).

In the sheet cassette or on the manual tray, the side end of the sheet is restricted by the side end restricting member, and further, the position of the rear end of the sheet is restricted by the rear end restricting member, so that the sheet can be stably fed irrespective of the size of the sheet.

FIG. 6 is a perspective view illustrating the configuration of the above-described sheet cassette in the prior art. A sheet cassette 80 includes side restricting plates 81a and 81b serving as side end restricting members in a slidable manner in a widthwise direction indicated by an arrow A, thus coping with various sheet sizes.

When the side restricting plates 81a and 81b are to be operated after sheets are stored, the sheet may be damaged when the side restricting plates 81a and 81b are operated full blast. Otherwise, if the sheets are not stored in accurate alignment with the center in the widthwise direction of the sheet cassette 80, the side restricting plates 81a and 81b are operated while the position of the stored sheets are shifted, thereby making an aligning operation cumbersome. Therefore, the side restricting plates 81a and 81b are set at positions in accordance with the sheet size before the sheets are stored in the prior art.

In contrast, when the side restricting plates 81a and 81b are set previously, the set side restricting plates 81a and 81b may be accidentally shifted from the set positions during a sheet storing operation or a feeding operation in which the sheet is fed in a sheet feed direction indicated by an arrow B. In this case, the sheet may be deficiently fed, the sheet may be jammed, and a printed image is misregistered.

In view of this, the sheet tray 80 is provided with a lock mechanism for locking the side restricting plates 81a and 81b at the set positions by allowing, for example, fine wedges to mesh with each other in the prior art. Such a lock mechanism is exemplified by predetermined grooves 82, which are formed at a bottom surface of the sheet tray 80 and arranged in a belt-like manner in parallel to a slide direction, and a knob 83, which can be vertically pivoted on a shaft 83a in the side restricting plate 81a. When the side restricting plate 81a is locked, a projection, not illustrated, formed at the bottom surface of the knob 83 engages with the groove 82.

When the side restricting plates 81a and 81b are slid, first, the knob 83 is pivoted upward by pinching the upper end thereof so that the projection of the knob 83 disengages from the groove 82, thereby releasing the lock. Thereafter, the side restricting plates 81a and 81b are slid in the direction indicated by the arrow A while holding the knob 83 in the upward pivoted state.

Next, when the side restricting plates 81a and 81b reach the positions in accordance with the size of the sheets to be stored, the knob 83 is pivoted downward. In this manner, the side restricting plates 81a and 81b can be locked at arbitrary positions at which they can restrict the positions of the sheets of not only a predetermined regular size but also an irregular size. A lock mechanism for locking the rear end restricting member also has the above-described configuration, and therefore, the rear end restricting member can be locked at arbitrary positions at which they can restrict the positions of the sheets of not only the predetermined regular size but also the irregular size.

In the conventional sheet feeding device provided with the above-described lock mechanisms, the knob for unlocking the restricting member is operated in a direction perpendicular to the slide direction of the restricting member. Specifically, the knob operation direction is different from the knob movement direction. As a consequence, a knob operating method or the knob operation direction is hardly understood. Otherwise, the knob need be pinched when the knob is operated, and therefore, the restricting member cannot be readily moved.

Thus, in view of these circumstances, the present invention provides a sheet feeding device capable of moving a restricting member by a simple operation and an image forming apparatus.

### SUMMARY OF THE INVENTION

According to the present invention, in a sheet feeding device including a sheet supporting portion which supports sheets and a restricting member which is movably disposed in the sheet supporting portion and is moved to restrict the position of the sheets supported by the sheet supporting portion, there is provided a lock mechanism which restricts movement of the restricting member in a direction reverse to a sheet restricting direction, and the lock mechanism comprises a lock projection which is disposed in the restricting member so as to be pivotable in a movement direction of the restricting member and a plurality of lock grooves which are formed on a side of the sheet supporting portion and disengageably engage with the lock projection, so as to restrict movement of the restricting member in a direction reverse to a sheet restricting direction, wherein the pivotal center of the lock projection in the lock mechanism is located downward of the position of an engaging portion between the lock projection and the lock groove.

According to the present invention, the lock projection is pivotally supported along the movement direction of the restricting member, and further, the pivotal center of the lock projection is disposed downward of the engaging portion between the lock projection and the lock groove, thus moving the restricting member by a simple operation.

Further features of the present invention will become apparent from the following description of exemplary embodiments (with reference to the attached drawings).

### BRIEF DESCRIPTION OF THE DRAWINGS

FIG. 1 is a view schematically illustrating the configuration of a color laser beam printer exemplifying an image forming apparatus provided with a sheet feeding device in an exemplary embodiment according to the present invention;

FIG. 2 is a perspective view illustrating the configuration of a manual sheet feeding device provided in the color laser beam printer;

FIG. 3 is a bottom view illustrating a sheet stack in the manual sheet feeding device;

FIG. 4 is a partly enlargement view illustrating a lock mechanism provided in the manual sheet feeding device;

FIGS. 5A and 5B are views illustrating the operation of the lock mechanism in the manual sheet feeding device; and

FIG. 6 is a perspective view illustrating a sheet cassette in the prior art.

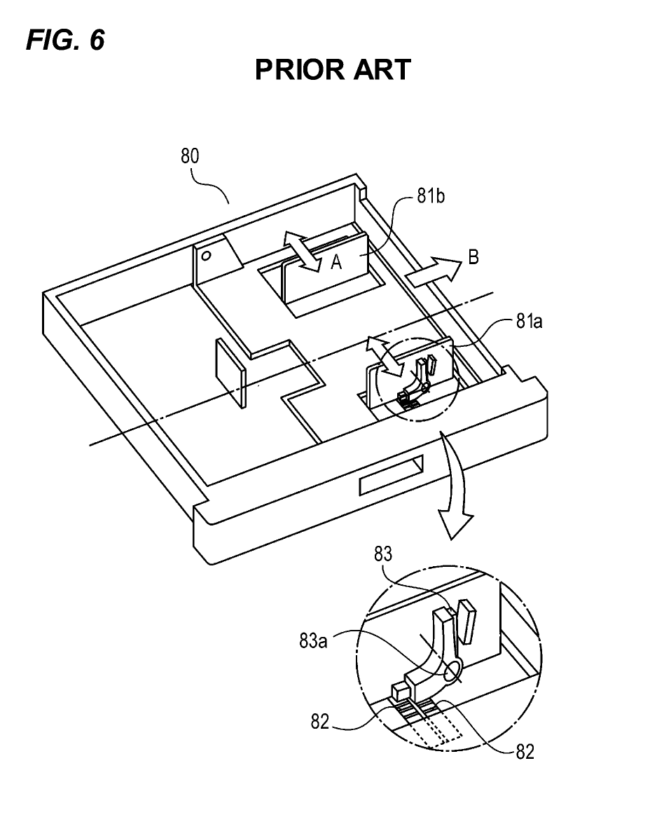

### DESCRIPTION OF THE EMBODIMENT

A detailed description will be given below of an exemplary embodiment carrying out the present invention with reference to the attached drawings.

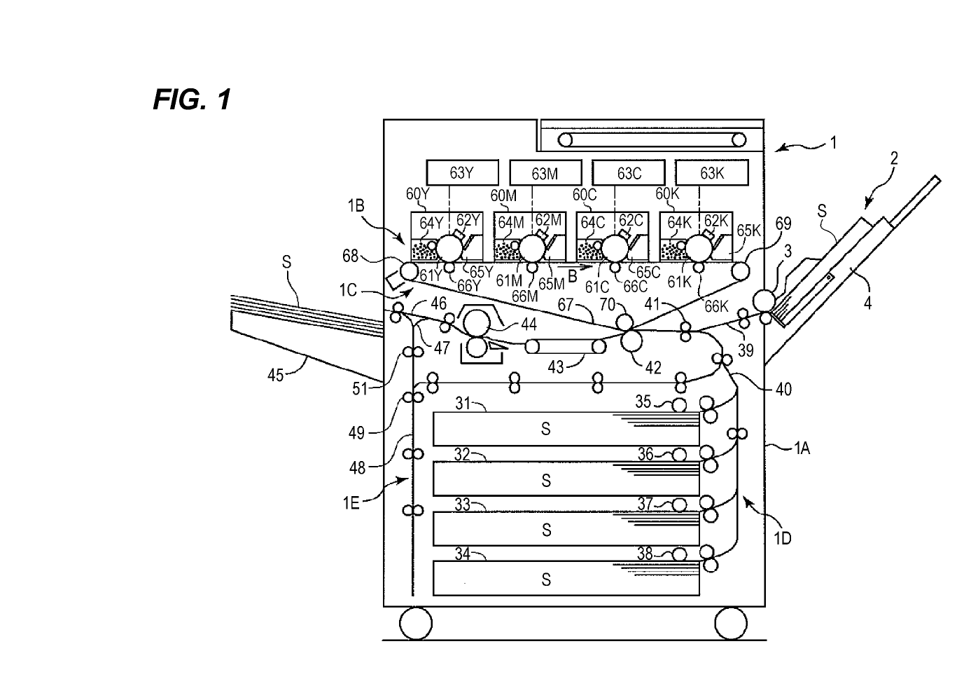

FIG. 1 is a view schematically illustrating the configuration of a color laser beam printer exemplifying an image forming apparatus provided with a sheet feeding device in an exemplary embodiment according to the present invention.

In FIG. 1, there is illustrated a color laser beam printer 1 including a color laser beam printer body (hereinafter referred to as a printer body) 1A. The printer body 1A includes an image forming portion 1B which forms an image on a sheet S, an intermediate transfer portion 1C, a fixing device 44, a sheet feeding device 1D which feeds the sheet S to the image forming portion 1B, and a manual sheet feeding device 2 which manually feeds the sheet. Incidentally, the color laser beam printer 1 can form an image on a reverse of a sheet. Therefore, there is provided a re-conveying portion 1E which reverses the sheet S having an image formed on an obverse (i.e., one surface) thereof, and then, conveys the sheet S again to the image forming portion 1B.

Here, the image forming portion 1B is disposed in a substantially horizontal direction, and includes four process stations 60 (60Y, 60M, 60C, and 60K) for forming toner images of four colors, that is, yellow (Y), magenta (M), cyan (C), and black (Bk), respectively.

The process stations 60 bear toner images of the four colors, that is, yellow, magenta, cyan, and black, and further, include photosensitive drums 61 (61Y, 61M, 61C, and 61K) serving as image bearing members to be driven by stepping motors, not illustrated. In addition, the process stations 60 include chargers 62 (62Y, 62M, 62C, and 62K) for uniformly charging the surfaces of the photosensitive drums.

Moreover, there are provided scanners 63 (63Y, 63M, 63C, and 63K) for irradiating the photosensitive drums, which are rotated at a constant speed, with laser beams based on image information so as to form electrostatic latent images on the photosensitive drums. Additionally, the process stations 60 include developing devices 64 (64Y, 64M, 64C, and 64K) for allowing yellow, magenta, cyan, and black toners to adhere onto the electrostatic latent images formed on the photosensitive drums so as to develop them into toner images. These charger 62, scanner 63, and developing device 64 are arranged around the photosensitive drum 61 in a rotational direction.

The sheet feeding device 1D is provided in the lower portion of the printer body. The sheet feeding device 1D is provided with sheet cassettes 31 to 34 serving as sheet containers for storing the sheets S therein and pick-up rollers 35 to 38 for picking up the sheets S stacked on and stored in the sheet cassettes 31 to 34, respectively. The manual sheet feeding device 2 includes a manual tray 4 serving as a sheet supporting portion for stacking and supporting the sheet S and a sheet feeding roller 3 for feeding the sheet S stacked on the manual tray 4.

Upon start of an image forming operation, the sheets S are separated and fed one by one from the sheet cassettes 31 to 34 by the pick-up rollers 35 to 38. Thereafter, the sheet S passes through a vertical conveying path 40, and then, is conveyed between a pair of registration rollers 41. In the case of manual sheet feeding, the sheet S stacked on the manual tray 4 passes through a conveying path 39 by the sheet feeding roller 3, and then, is conveyed between the pair of registration rollers 41.

Here, the registration rollers 41 have the function of correcting a skew feeding by registering the tip of the sheet S owing to the formation of a loop in abutment against the sheet S. Moreover, the registration rollers 41 have the function of conveying the sheet S to a secondary transfer portion at a timing of image formation on the sheet S, that is, a predetermined timing with the toner images born on an intermediate transfer belt, described later.

When the sheet S is conveyed, the registration rollers 41 are stopped. The sheet S abuts against the stopped registration rollers 41, and therefore, has a loop. Thereafter, the tip of the sheet S is registered at a nip portion defined between the registration rollers 41 owing to the rigidity of the sheet S, so that the skew feeding of the sheet S is corrected. After the skew feeding of the sheet S is corrected, the registration rollers 41 are driven at a timing at which the toner images formed on an intermediate transfer belt 31 and the tip of the sheet S are registered with each other, as described later.

The intermediate transfer portion 1C is provided with the intermediate transfer belt 67 which is rotationally driven in the arrangement direction of the process stations 60, as indicated by an arrow, in synchronism with a peripheral speed of the photosensitive drum 61. Here, the intermediate transfer belt 67 is stretched between a driving roller 68, a driven roller 70 which forms a secondary transfer region between the intermediate transfer belt 67 and the same, and a tension roller 69 which applies a proper tension to the intermediate transfer belt 67 by resiliency of a spring, not illustrated.

The intermediate transfer belt 67 is stretched around four primary transfer rollers 66 (66Y, 66M, 66C, and 66K) which hold the intermediate transfer belt 67 in cooperation with their respective photosensitive drums 61 and constitute a primary transfer portion. The primary transfer rollers 66 are connected to transfer biasing power sources, not illustrated. The color toner images formed on the photosensitive drums are sequentially transferred in superimposition on the intermediate transfer belt 67 by applying a transfer bias from the primary transfer rollers 66 to the intermediate transfer belt 67, and thus, a full color image is formed on the intermediate transfer belt 67.

A secondary transfer roller 42 is disposed opposite to the driven roller 70. The secondary transfer roller 42 abuts against the lowermost surface of the intermediate transfer belt 67, and further, nips and conveys the sheet S conveyed through the registration rollers 41 in cooperation with the intermediate transfer belt 67. When the sheet S passes through a nip portion defined between the secondary transfer roller 42 and the intermediate transfer belt 67, the toner image formed on the intermediate transfer belt is secondarily transferred onto the sheet S by applying a bias to the secondary transfer roller 42.

The fixing device 44 is adapted to fix, onto the sheet S, the toner image formed on the sheet via the intermediate transfer belt 67. The toner image is fixed onto the sheet S by applying heat and pressure to the sheet S having the toner image formed thereon when it passes the fixing device 44.

Next, an image forming operation in the color laser beam printer 1 such configured as described above will be described below.

Upon start of the image forming operation, the scanner 63Y irradiates the photosensitive drum 61Y with the laser beam in the process station 60Y located most upstream in the rotational direction of the intermediate transfer belt 67, thereby forming a yellow latent image on the photosensitive drum. Thereafter, the developing device 64Y develops the latent image with a yellow toner, thereby forming a yellow toner image.

Next, the yellow toner image formed on the photosensitive drum 61Y in the above-described manner is primarily transferred onto the intermediate transfer belt 67 in a primary transfer region by the transfer roller 66Y, to which a high voltage is applied. Subsequently, the toner image is conveyed on the intermediate transfer belt 67 to another primary transfer region defined between the photosensitive drum 61M and the transfer roller 66M in the next process station 60M in which an image is formed with a delay by a time of conveyance of the toner image from the process stations 60Y.

A next magenta toner image is transferred by registering the tip of the image on the yellow toner image formed on the intermediate transfer belt. By repetition of the same process, the toner images of the four colors are primarily transferred onto the intermediate transfer belt 67, so that a full color image is formed on the intermediate transfer belt. The residual transfer toner remained in a small quantity on the photosensitive drums are recovered by photosensitive drum cleaners 65 (65Y, 65M, 65C, and 65K), and then, the photosensitive drums prepare for a next image formation.

Along with the above-described toner image forming operation, the sheets S stored on the sheet cassettes 31 to 34 are separated and fed one by one by the pick-up rollers 35 to 38, respectively, to be conveyed to the registration rollers 41. In the case of the manual sheet feeding, the sheet S stacked on the manual tray 4 is conveyed by the sheet feeding roller 3, passes through the conveying path 39, and is conveyed to the registration rollers 41.

At this time, the registration rollers 41 are stopped. The sheet S abuts against the stopped registration rollers 41, so that the skew feeding of the sheet S is corrected. After the skew feeding is corrected, the sheet S is conveyed to the nip portion defined between the secondary transfer roller 42 and the intermediate transfer belt 67 by the registration rollers 41 which are started to be rotated at a timing at which the tip of the sheet registers with the toner image formed on the intermediate transfer belt 67.

While the sheet S is nipped between the secondary transfer roller 41 and the intermediate transfer belt 67 and conveyed therethrough, the toner image formed on the intermediate transfer belt is secondarily transferred onto the sheet S by a bias applied to the secondary transfer roller 41 when the sheet S passes through the nip portion defined between the secondary transfer roller 41 and the intermediate transfer belt 67.

Subsequently, the sheet S having the toner image secondarily transferred thereonto is conveyed to the fixing device 44 by a pre-fixing conveying apparatus 43. The fixing device 44 fuses and fixes the toner image onto the sheet S with the application of a predetermined pressure by opposite rollers or a belt and a heat generated by a heat source such as a heater, in general.

The sheet S is selectively conveyed on a discharged sheet conveying path 46 in the case where the sheet S having the fixed image such obtained as described above is discharged onto a discharge tray 45 as it is or on a reverse guide path 47 in the case where duplex image formation is performed. In the case of the duplex image formation, the sheet S is drawn from the reverse guide path 47 to a switchback path 48. And then, the sheet S is conveyed to a duplex conveying path 50 by switching the fore and rear tips by a switchback operation for rotating a second reverse roller pair 49 forward or reversely.

Thereafter, the sheet S is conveyed again at a timing at which the sheet S for a subsequent job conveyed by the pickup rollers 35 to 38 or the sheet feeding roller 3, and then, is conveyed to the secondary transfer portion through the registration rollers 41 in the same manner. A subsequent image forming process for a reverse (i.e., a second surface) is performed in the same manner as in the above-described obverse (i.e., a first surface).

When the sheet S is reversely discharged, the sheet S passes through the fixing device 44, to be then drawn from the reverse guide path 47 to the switchback path 48. The drawn sheet S is conveyed reversely to the fed-in direction in which the fed-in rear end is set to the leading position by reverse rotation of a first reverse roller pair 51, to be discharged onto the discharge tray 45.

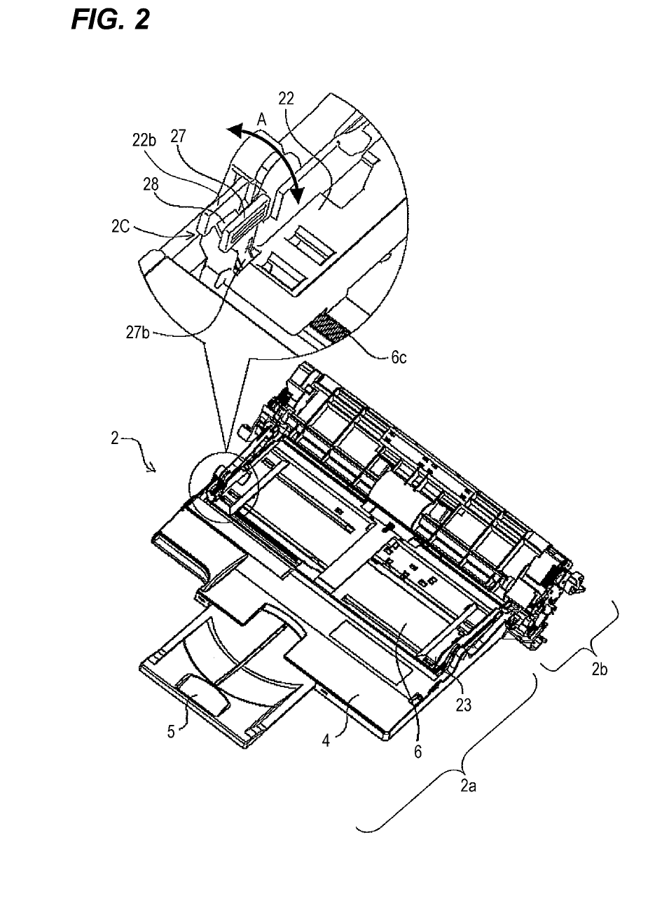

On the other hand, as illustrated in FIG. 2, the manual sheet feeding device 2 includes a sheet stack 2a provided with the manual tray 4, an extension tray 5 disposed drawably from the manual tray 4, and an elevatable inner plate 6 for bringing the stacked sheet S into or out of contact with the sheet feeding roller 3. The manual sheet feeding device 2 additionally includes a sheet feeding device 2b which is provided with the sheet feeding roller 3 and is adapted to feed the sheets S stacked on the sheet stack 2a serving as a sheet supporting portion to the image forming apparatus one by one.

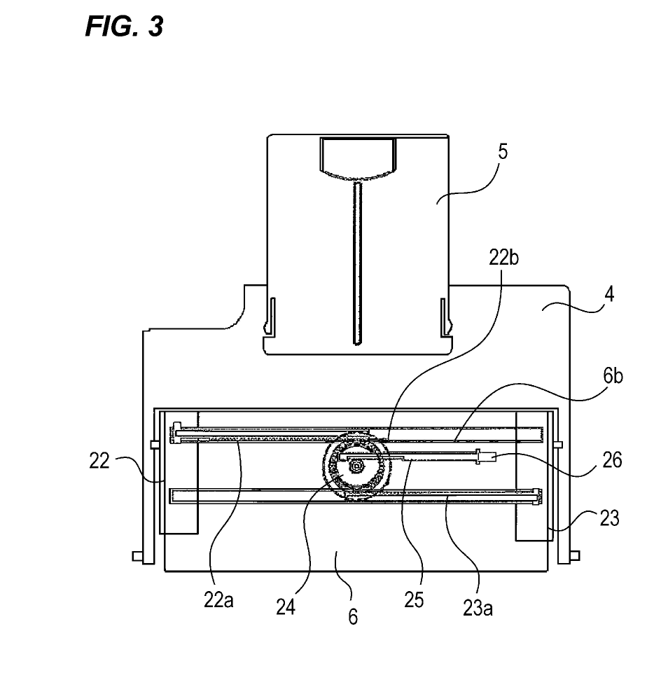

Here, a couple of side restricting plates 22 and 23 for restricting the side end position of the sheet S are arranged slidably (movably) in a widthwise direction perpendicular to the sheet feed direction on the inner plate 6 which is disposed in the sheet stack 2a and constitutes the sheet supporting portion in cooperation with the manual tray 4. Rack gears 22a and 23a extending in the widthwise direction are disposed, respectively, at lower ends of the side restricting plates 22 and 23 serving as restricting members for restricting the side end position of the sheet S, as illustrated in FIG. 3. The rack gears 22a and 23a mesh with a pinion gear 24 rotatably supported at substantially the center of the lower surface of the inner plate 6.

With the above-described configuration, either one of the side restricting plates 22 and 23 can be operated in association only by widthwise sliding the other one of the side restricting plates 22 and 23, thereby improving user operability. Moreover, the widthwise center of the sheet S and the widthwise center of the image can substantially register with each other even if the side restricting plates 22 and 23 are located at any position, thus enhancing the positional precision of the image with respect to the sheet.

In FIG. 3, a size detection lever 25 is widthwise moved in association with the slide operation of the side restricting plates 22 and 23. At the end of the size detection lever 25 is provided with a slide potentiometer 26. When the side restricting plates 22 and 23 are slid, the size detection lever 25 is moved, so that the sheet width size can be automatically detected according to the positions of the side restricting plates 22 and 23 based on a deviation of the slide potentiometer 26 in association with the movement of the size detection lever 25. Consequently, it is possible to prevent a trouble such as sheet jamming or an image blank caused by an erroneous operation of size setting by a user.

Also in FIG. 3, a click spring 22b is disposed at the lower end of the side restricting plate 22. The click spring 22b is designed to be fitted to a plurality of click grooves 6b formed on the inner plate 6 according to various regular sizes of sheets in association with the slide operation of the side restricting plate 22. As a consequence, it is easy to recognize the positions of the side restricting plates 22 and 23 according to the regular sizes, thus enhancing the user operability.

As illustrated again in FIG. 2, a knob member 27 serving as an operation portion turnably supported along the movement direction of the side restricting plate 22 indicated by an arrow A is disposed in the side restricting plate 22. At the lower end of the knob member 27 is integrally formed a lock projection 27b serving as a projection capable of disengageably engaging with a plurality of lock grooves 6c formed at the inner plate 6 at equal intervals in the widthwise direction.

The lock projection 27b engages with the plurality of lock grooves 6c formed at the inner plate 6, that is, on the side of the sheet supporting portion, so that the side restricting plates 22 and 23 can be held (locked) at predetermined sheet restriction positions. In other words, the lock projection 27b and the plurality of lock grooves 6c formed at the inner plate 6 constitute a lock mechanism 2c for restricting any movement reverse to the sheet restricting direction of the side restricting plates 22 and 23 in the present embodiment.

Here, the lock projection 27b is urgingly held in a direction in which it is pressed against the lock groove 6c by resiliency of a knob urging spring 28. For example, the knob member 27 is pinched by two fingers together with a wall 22b of the side restricting plate 22, so that the knob member 27 can be retracted from the lock groove 6c.

When the lock projection 27b is retracted from the lock groove 6c in the above-described manner, the side restricting plates 22 and 23 are released from being held. Thereafter, the side restricting plates 22 and 23 can be smoothly slid.

As described above, the knob member 27 is operated in substantially the same direction as the slide direction of the side restricting plates 22 and 23 in the present embodiment, and therefore, the operation method and the operation direction are readily understood, thus enhancing the user operability. Also in the present embodiment, an interval between the lock grooves 6c and an interval between the lock projections 27b are set to as fine as 0.5 mm. As a consequence, the side restricting plates 22 and 23 can be positionally adjusted and lockingly held at proper positions according to the width of a sheet S of an irregular size for which no click groove 6b illustrated in FIG. 3 is formed. Thus, the present invention can be applied to various sheet sizes.

Incidentally, the interval between the lock grooves 6c and the interval between the lock projections 27b are not limited to 0.5 mm as long as the lock projection 27b is securely fitted to the lock groove 6c, and further, the knob member 27 can be positioned according to the size of the sheet to be used. For example, the interval between the lock grooves 6c may be set to 1 mm, and further, the interval between the lock projections 27b maybe set to half, that is, 0.5 mm, so that such a lock projection may be fitted to such a groove.

When the side restricting plates 22 and 23 are set to a predetermined sheet size, and then, the sheet S is placed on the inner plate 6, the side restricting plates 22 and 23 may receive an external force from the sheet S which abuts on the inner side. Likewise, the side restricting plates 22 and 23 may receive an external force from the sheet S from the inside in the case where the sheet S being fed skews. At this time, if the external force moves the side restricting plates 22 and 23 in a direction away from the sheet S in which an interval between the side restricting plates 22 and 23 becomes wider, widthwise restriction for the sheet S is insufficient, thereby possibly causing a trouble such as a skew feeding or degradation of image position precision on the sheet S.

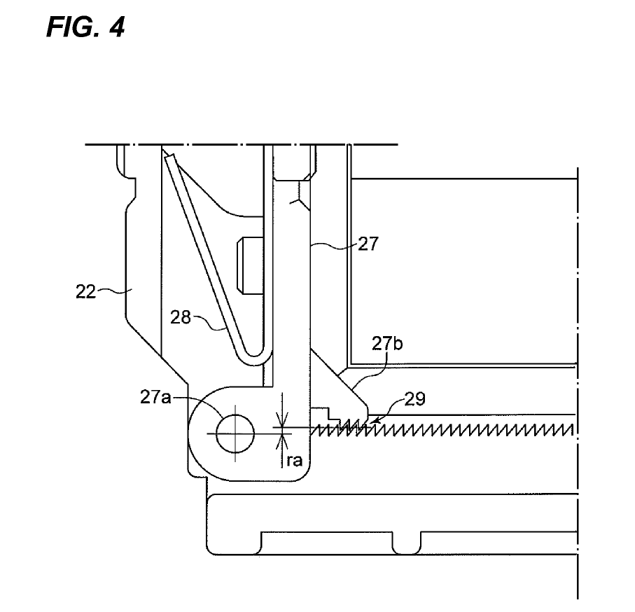

In the present embodiment, as illustrated in FIG. 4, the lock projection 27b and the lock groove 6c are formed such that abutment surfaces thereof become substantially perpendicular to each other in the case where the side restricting plates 22 and 23 are slid in a direction reverse to the sheet restricting direction, that is, in a direction in which the interval between the side restricting plates 22 and 23 becomes wider. In contrast, the abutting surfaces of the lock projection 27b and the lock groove 6c in the case where the side restricting plates 22 and 23 are slid in the sheet restricting direction, that is, in a direction in which the interval between the side restricting plates 22 and 23 becomes narrower are inclined.

Specifically, the plurality of lock grooves 6c have the inclined surfaces in abutment against the lock projection 27b when the side restricting plates 22 and 23 are moved in the sheet restricting direction. In addition, the plurality of lock grooves 6c have vertical surfaces for generating restricting force for restricting the movements of the side restricting plates 22 and 23 in engagement with the lock projection 27b when the force reverse to the sheet restricting direction is applied to the side restricting plates 22 and 23.

The lock projection 27b includes the inclined surface in abutment against the inclined surface of the lock groove 6c when the side restricting plates 22 and 23 are moved in the sheet restricting direction. Moreover, the lock projection 27b includes the vertical surface in abutment against the vertical surface of the lock groove 6c when the force is applied to the side restricting plates 22 and 23 in the direction reverse to the sheet restricting direction.

The center of a rotary shaft 27a of the knob member 27 is located downward of an abutting portion (i.e., an engaging portion) 29 at which the lock projections 27b and the lock grooves 6c abut against (i.e., engages with) each other. In the present embodiment, as illustrated in 5A, the rotary shaft 27a of the knob member 27 is located downward by a quantity ra of the abutting portion 29.

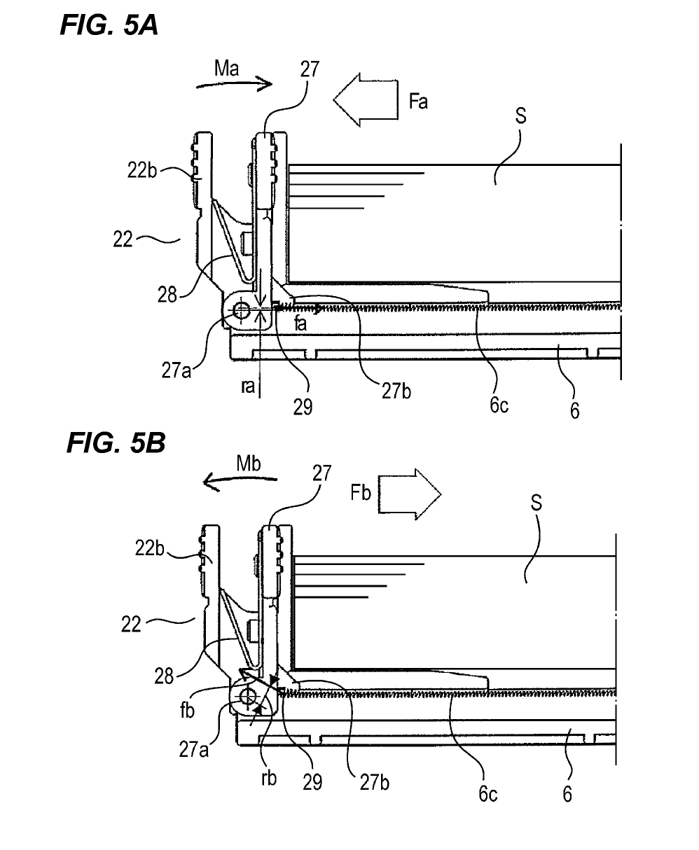

With this configuration, when, for example, the side restricting plate 22 receives the external force from the inside, the vertical surfaces of the lock projection 27b and the lock groove 6c abut against each other, so that a reaction fa in a horizontal direction perpendicular to the vertical surface acts on the knob member 27 at the abutting portion 29. At this time, the rotary shaft 27a of the knob member 27 is disposed by the quantity ra downward of the abutting portion 29, as described already, and therefore, a moment Ma exerted on the knob member 27 is represented by the equation: Ma =fax ra, and further, acts clockwise, as illustrated in FIG. 5A. In other words, the side restricting plate 22 receives an external force Fa from the inside, the clockwise force expressed by the moment Ma is exerted on the knob member 27 due to the external force Fa, as illustrated in FIG. 5A.

Here, since the moment Ma is exerted in a direction in which the lock projection 27b presses the lock groove 6c, the lock projection 27b cannot float from the lock groove 6c even if the external force Fa acts, so that the lock state can be securely held. As a consequence, even if the side restricting plate 22 receives the external force Fa from the inside, that is, the side restricting plate 22 receives force for moving the side restricting plate 22 reversely to the sheet restricting direction, the side restricting plates 22 and 23 cannot be moved.

In the meantime, when the side restricting plate 22 is moved in the sheet restricting direction when the sheet of a small size is stored, an external force Fb is exerted on the side restricting plate 22 from the outside. When the side restricting plate 22 receives the external force Fb from the outside in the above-described manner, the inclined surfaces of the lock projection 27b and lock groove 6c abut against each other, so that an upward and leftward reaction fb perpendicular to the inclined surface acts on the knob member 27 at the abutting portion 29, as illustrated in FIG. 5B. At this time, since the rotary shaft 27a of the knob member 27 is located downward of the abutting portion 29, as described above, the rotary shaft 27a of the knob member 27 is located downward by a quantity rb also in the direction of the reaction fb.

Therefore, a moment Mb exerted on the knob member 27 is represented by the equation: Mb=fb×rb, and further, acts counterclockwise, as illustrated in FIG. 5B. In other words, in the case where the side restricting plate 22 receives the external force Fb from the outside, the counterclockwise force expressed by the moment Mb is exerted on the knob member 27 due to the external force Fb, as illustrated in FIG. 5B.

Here, the moment Mb acts in a direction in which the lock projection 27b floats to be unlocked from the lock groove 6c, so that the lock projection 27b is moved by the moment Mb in the direction in which the lock is released when the external force Fb acts. As a consequence, in the case where the side restricting plate 22 receives the external force from the outside, that is, the side restricting plate 22 receives force for moving the side restricting plate 22 in the sheet restricting direction, the lock is released so that the side restricting plates 22 and 23 can be moved.

With the configuration in the present embodiment, when the side restricting plate 22 is moved in a direction in which the distance between the side restricting plates 22 and 23 is longer, at first, the knob member 27 and the side restricting plate 22 are pinched by, for example, two fingers. Next, the knob member 27 is turned to abut against the wall 22b of the side restricting plate 22, so that the lock projection 27b floats from the lock groove 6c, thereby releasing the lock. Thereafter, while the knob member 27 abuts against the wall 22b of the side restricting plate 22, the side restricting plate 22 is operated in the direction in which the distance between the side restricting plates 22 and 23 is longer.

With the configuration in the present embodiment, when the side restricting plate 22 is operated in the direction in which the distance between the side restricting plates 22 and 23 is longer, the knob member 27 can be turned to be unlocked only by pushing the knob member 27 onto the wall 22b of the side restricting plate 22 by one finger. Thereafter, a pushing force is continuously applied, so that the side restricting plate 22 can be slid in the direction in which the distance between the side restricting plates 22 and 23 is longer.

Specifically, in the present embodiment, the side restricting plates 22 and 23 are unlocked or slid in the direction in which the distance between the side restricting plates 22 and 23 is longer by not only the operation in which the knob member 27 is held by the two fingers but also the operation in which the knob member 27 is pushed by one finger. That is to say, the side restricting plates 22 and 23 are unlocked or slid by pushing the knob member 27, that is one action with only one finger, thus enhancing the operability. Thus, the side restricting plates 22 and 23 can be moved by a simple operation even by a user who hardly pinches the knob member 27.

As described above, the lock projection 27b is pivotally disposed in the movement direction of the side restricting plates 22 and 23, so that the unlock direction and the slide direction of the side restricting plates 22 and 23 can accord with each other, thus making it easy to understand the operation method or direction of the knob member 27. The pivotal center of the lock projection 27b is located downward of the abutting portion 29 between the lock projection 27b and the lock groove 6c, so that the lock can be released by the simple operation, thus moving the side restricting plates 22 and 23.

As a consequence, it is possible to provide the manual sheet feeding device 2 and the color laser beam printer (i.e., the image forming apparatus) which is excellent in operability without any fear of sheet feeding deficiency, sheet jam, or positional deviation of a printed image. Moreover, the lock projection 27b is formed integrally with the knob member 27, thus suppressing the complication of the configuration or an increase in cost.

Although the lock mechanism for the side restricting plates 22 and 23 has been described above, the present invention is not limited to this. The same effect can be produced by configuring the lock mechanism for the rear end restricting member in the same manner. Although the configuration of the manual sheet feeding device 2 has been described above, the present invention can be applied to the sheet feeding device for feeding the sheets stored on the sheet cassettes 31 to 34. In addition, although the manual tray 4 provided with the inner plate 6 has been described above, the same effect can be produced by forming a lock groove at a bottom of a tray in the case of a manual tray without any inner plate 6.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-285471, filed Nov. 6, 2008, which is hereby incorporated by reference herein in its entirety.

What is claimed is:

1. A sheet feeding device comprising:
a sheet supporting portion which supports sheets;
a restricting member which is movably disposed in the sheet supporting portion and is moved to restrict the position of the sheets supported by the sheet supporting portion; and
a lock mechanism which restricts movement of the restricting member in a direction reverse to a sheet restricting direction, and the lock mechanism comprises a lock projection which is disposed in the restricting member so as to be pivotable in a movement direction of the restricting member and a plurality of lock grooves which are formed on a side of the sheet supporting portion and disengageably engage with the lock projection;
wherein the pivotal center of the lock projection in the lock mechanism is located downward of the position of an engaging portion between the lock projection and the lock groove.

2. The sheet feeding device according to claim 1, wherein the restricting member comprises an operation portion which is disposed pivotally in the movement direction of the restricting member, to release the lock of the restricting member by the lock mechanism, the lock projection being formed integrally with the operation portion so as to disengage the lock projection from the lock groove according to the operation of the operation portion.

3. The sheet feeding device according to claim 1, wherein the plurality of grooves each have an inclined surface abutting against the lock projection when the restricting member is moved in the sheet restricting direction and a vertical surface generating a restricting force for restricting the movement of the restricting member in engagement with the lock projection when force is exerted on the restricting member reversely to the sheet restricting direction; and
the lock projection has an inclined surface abutting against the inclined surface of the groove when the restricting member is moved in the sheet restricting direction and a vertical surface abutting against the vertical surface of the groove when the force is exerted on the restricting member reversely to the sheet restricting direction.

4. An image forming apparatus comprising:
an image forming portion; and
a sheet feeding device which feeds a sheet to the image forming portion and includes:
a sheet supporting portion which supports sheets;
a restricting member which is movably disposed in the sheet supporting portion and is moved to restrict the position of the sheets supported by the sheet supporting portion; and
a lock mechanism which restricts movement of the restricting member in a direction reverse to a sheet restricting direction, and the lock mechanism comprises a lock projection which is disposed in the restricting member so as to be pivotable in a movement direction of the restricting member and a plurality of lock grooves which are formed on a side of the sheet supporting portion and disengageably engage with the lock projection, so as to restrict movement of the restricting member in a direction reverse to a sheet restricting direction;
wherein the pivotal center of the lock projection in the lock mechanism is located downward of the position of an engaging portion between the lock projection and the lock groove.

5. The image forming apparatus according to claim 4, wherein the restricting member comprises an operation portion which is disposed pivotally in the movement direction of the restricting member, to release the lock of the restricting member by the lock mechanism, the lock projection being formed integrally with the operation portion so as to disengage the lock projection from the lock groove according to the operation of the operation portion.

6. The image forming apparatus according to claim 4, wherein the plurality of grooves each have an inclined surface abutting against the lock projection when the restricting member is moved in the sheet restricting direction and a vertical surface generating a restricting force for restricting the movement of the restricting member in engagement with the lock projection when force is exerted on the restricting member reversely to the sheet restricting direction; and
the lock projection has an inclined surface abutting against the inclined surface of the groove when the restricting member is moved in the sheet restricting direction and a vertical surface abutting against the vertical surface of the groove when the force is exerted on the restricting member reversely to the sheet restricting direction.
